(19) United States
(12) Patent Application Publication
(10) Pub. No.: US 2019/0264924 A1
(43) Pub. Date: Aug. 29, 2019

(54) Timing Assembly and Toaster Oven

(71) Applicant: Elec-Tech International Co., Ltd., Zhuhai City (CN)

(72) Inventors: Donglei WANG, Guangdong (CN); Hengjie YANG, Zhuhai City (CN); Tuo WANG, Zhuhai City (CN); Peirun LIU, Zhuhai City (CN)

(21) Appl. No.: 16/300,366

(22) Filed: Nov. 9, 2018

Related U.S. Application Data
(63) Continuation of application No. PCT/CN2016/097203, filed on Aug. 29, 2016.

(30) Foreign Application Priority Data
May 10, 2016 (CN) 201620423173.9

(51) Int. Cl. F24C 7/08; G04F 3/00; A47J 37/06

(52) U.S. Cl. CPC F24C 7/087; A47J 37/0629; G04F 3/00

(57) ABSTRACT

Disclosed are a timing assembly (500) and a toaster oven, the timing assembly (500) including: a mounting panel (200); a knob assembly (100) including a knob portion (110) and a movable assembly (120), the movable assembly (120) having a first state and a second state; a timer (300); and a limiting member fixedly connected to the mounting panel (200), the limiting member being positioned corresponding to the movable assembly (120) in the first state; when the movable assembly (120) in the first state is rotated to the position of the limiting member, the limiting member blocks the movable assembly (120) from continuing to rotate, and when the movable assembly (120) in the second state is rotated, the limiting member is avoided. The toaster oven includes the timing assembly (500). The timing assembly (500) can safely switch among operating states, and prevents safety risks.

### CROSS REFERENCE TO RELATED APPLICATIONS

This application is a continuation under 35 U.S.C. § 120 of international patent application PCT/CN2016/097203 filed on Aug. 29, 2016, which claims priority to Chinese patent application No. 201620423173.9, filed on May 10, 2016, entitled “TIMING ASSEMBLY AND TOASTER OVEN”, and the entire contents of which are incorporated herein by reference.

### TECHNICAL FIELD

The disclosure relates to the technical field of applications of the timer, in particular to a timing assembly and a toaster oven having same.

### BACKGROUND

Typically, for a timer used on an apparatus, a knob of the timer is rotated in a first direction (such as in a clockwise direction) to set the time of the timer. After finishing setting, the apparatus starts to work, and the knob of the timer rotates back automatically in a second direction (usually in a counterclockwise direction). When working time of the apparatus reaches the set time of the timer, the apparatus and the timer stop working at the same time, and the knob will automatically return to the “OFF” position.

However, for some timers, since an acceptable maximum set time is relatively short, while needed working time of the apparatus is longer, in this case, the timer needs to have a stay-on function. The apparatus remains in a working state under the stay-on condition, and the timer also remains in a working state under the stay-on condition. In the case of the timer having such a structure, when the set working time of the timer exceeds the actual needed working time of the apparatus, the user needs to manually reset the timer to zero to turn off the timer, so as to turn off the apparatus. The direction of rotating the timer from the working state to the zeroing state is the second direction, while the direction for choosing the stay-on condition is also the second direction, thus the user may turn the timer to the stay-on condition. In this case, the user may think that the apparatus is turned off but the apparatus is actually in the working state, which can cause safety risks.

### SUMMARY

In view of this, it is necessary to provide a timing assembly that has an improved safety to solve the above problem.

On one aspect of the present disclosure, a timing assembly is provided, including:

a mounting panel;

a knob assembly, including a knob portion and a movable assembly, the knob portion being located at one side of the mounting panel, the knob potion being rotatable relative to the mounting panel, and the movable assembly being connected to the knob portion and capable of rotating with the knob potion, and the movable assembly having a first state and a second state;

a timer, comprising a body and a shaft, the body being located at another side of the mounting panel, and the body being fixedly connected to the mounting panel, and the shaft being disposed on the body, and the shaft and the knob portion being fixedly connected; and

a limiting member, fixedly connected to the mounting panel, the limiting member being positioned at a location corresponding to the movable assembly in the first state, when the movable assembly in the first state is rotated to the location of the limiting member, the limiting member being able to block the movable assembly from continuing rotating, and when the movable assembly in the second state is rotated, the movable assembly being able to avoid the limiting member.

In one embodiment, the movable assembly includes a button and an elastic component, and the button is connected to the knob portion by the elastic component.

In one embodiment, the elastic component is a spring.

In one embodiment, the button is in a non-pressed state when the movable assembly is in the first state, and the button is in a pressed state when the movable assembly is in the second state.

In one embodiment, the knob portion includes a connection column and a barrel portion, and the connection column is disposed at a bottom of the barrel portion, and the connection column is fixedly connected to the shaft;

an opening is disposed on a sidewall of the barrel portion, a part of the button is located in the opening, and another part of the button enters into the barrel portion, and the elastic component is located between the button and the connection column, so that the button is elastically coupled to the connection column.

In one embodiment, the part of the button that enters into the barrel portion has a protrusion disposed at a side facing the connection column, and the elastic component is sleeved on the protrusion.

In one embodiment, the knob assembly further includes an anti-detachment structure, and the anti-detachment structure is able to prevent the elastic component and/or the button from detaching from the knob portion.

In one embodiment, the anti-detachment structure includes a retaining ring, and the retaining ring is disposed inside the opening, and fits with the opening by a transition fit or an interference fit, and the retaining ring mates with the button.

In one embodiment, the limiting member includes a baffle, and the baffle is disposed on the mounting panel, and protrudes out of the mounting panel.

On another aspect, the present disclosure provides a toaster oven including a toaster oven body and a timing assembly, wherein the timing assembly is disposed on the toaster oven body.

Advantages and beneficial effects of the present disclosure are as follows: according to the timing assembly of the present disclosure, since the timing assembly is provided with a limiting member fixedly connected to the mounting panel, and the limiting member is positioned at a location corresponding to the movable assembly in the first state, when the movable assembly in the first state is rotated to the location of the limiting member, the limiting member is able to block the movable assembly from continuing rotating, and when the movable assembly in the second state is rotated, the movable assembly is able to avoid the limiting member. When the movable assembly is in the first state, the timer can be automatically turned off after reaching a preset time, which can prevent the timer from switching to a stay-on mode caused by a failure of the timer or due to other reasons, thereby preventing the apparatus from being in the working state all the time and resulting in potential safety risks. When a user wants to use the timing assembly under the stay-on mode, the user only needs to make the movable assembly to be in the second state, and the knob assembly can be switched to the stay-on mode by the limiting member. The disclosure has a simple structure and is able to avoid potential safety risks.

### BRIEF DESCRIPTION OF DRAWINGS

In order to illustrate the embodiments of the present disclosure or the technical solutions in the prior art more clearly, the drawings to be used in the embodiments or the prior art will be briefly described below. Obviously, the drawings in the following description are only some embodiments of the present disclosure, and those skilled in the art can obtain other drawings according to these drawings without any creative work.

FIG. 1 is a structural diagram of a timing assembly in accordance with one embodiment of the disclosure;

FIG. 2 is a structural diagram of a knob assembly of the timing assembly shown in FIG.1;

FIG. 3 is an assembly diagram of the knob assembly of the timing assembly shown in FIG. 2;

FIG. 4 is partial schematic view of a mounting panel of the timing assembly shown in FIG. 1;

FIG. 5 is a sectional view of the timing assembly in a first state shown in FIG. 1 in accordance with one embodiment of the disclosure;

FIG. 6 is a sectional view of the timing assembly in a second state shown in FIG.1 in accordance with one embodiment of the disclosure;

FIG. 7 is a diagram illustrating a working scene for the timing assembly shown in FIG. 1 in accordance with one embodiment;

FIG. 8 is a structural diagram of a toaster oven in accordance with one embodiment;

In the drawings: 100-knob assembly, 110-knob portion, 112-connection column, 114-barrel portion, 120-movable assembly, 122-button, 124-spring, 200-mounting panel, 201-baffle, 300-timer, 301-body, 302-shaft, 400-toaster oven body, 500-timing assembly.

### DETAILED DESCRIPTION OF PREFERRED EMBODIMENTS

The present disclosure will be described in more details below with reference to relevant drawings and embodiments. It should be understood that the embodiments described herein are merely used for explaining technical solutions of the present disclosure, rather than for limiting the scope of the present disclosure.

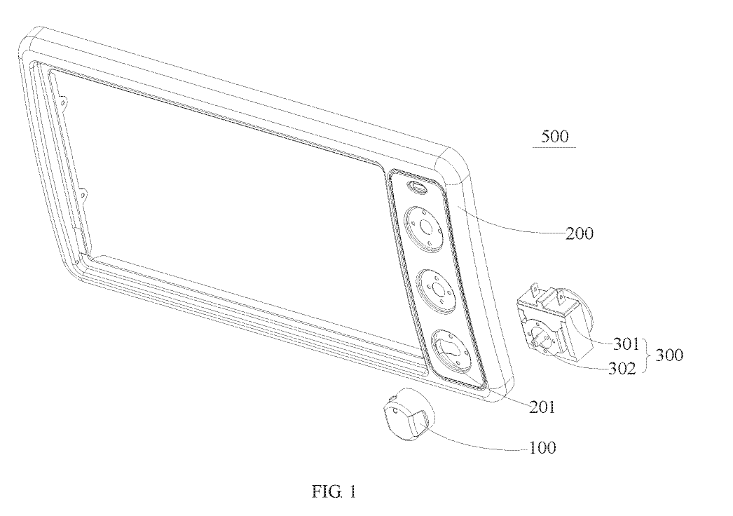

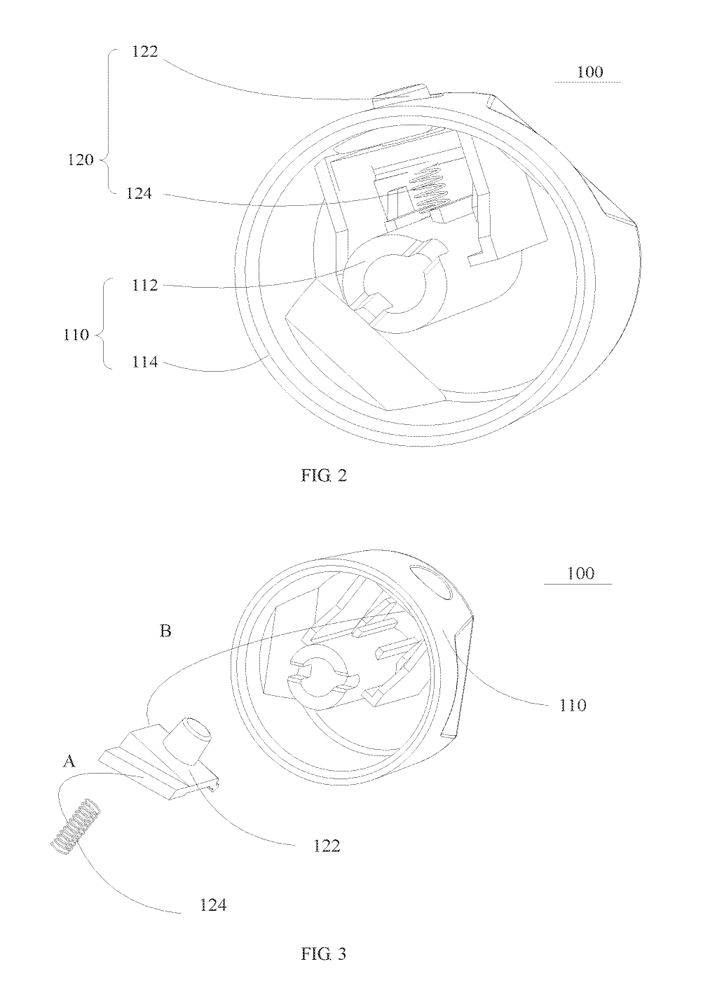

Referring to FIG. 1 and FIG. 2, a structural diagram of a timing assembly 500 according to one embodiment is shown, and a knob assembly 100 of the timing assembly 500 shown in FIG.1 is illustrated. The timing assembly 500 of the embodiment includes a mounting panel 200 and a knob assembly 100. The knob assembly 100 includes a knob portion 110 and a movable assembly 120. The knob portion 110 is located at one side of the mounting panel 200, the knob potion is rotatable relative to the mounting panel 200, wherein the knob portion 110 is capable of rotating not only in a first direction (usually in a clockwise direction) but also in a second direction (usually in a counterclockwise direction). And the movable assembly 120 is connected to the knob portion 110 and capable of rotating with the knob potion 110, wherein the definition of “rotating” here also should be understood as the above mentioned meaning. And the movable assembly 120 has two states, a first state and a second state respectively; wherein the first state is a state when choosing a non-stay-on mode, and the second state is a state when choosing a stay-on mode.

The timer 300 can have a mechanical timing structure. The timer 300 includes a body 301 and a shaft 302. Wherein, the body 301 is located at another side of the mounting panel 200 and is fixedly connected to the mounting panel 200. Wherein, the body 301 can be connected to the mounting panel 200 by bolts or screws; the shaft 302 is disposed on the body 301, and the shaft 302 is fixedly coupled to the knob portion 110.

A limiting member is fixedly connected to the mounting panel 200, the limiting member is positioned at a location corresponding to the movable assembly 120 in the first state; when the movable assembly 120 in the first state is rotated to the location of the limiting member, the limiting member is able to block the movable assembly from continuing rotating, and when the movable assembly in the second state is rotated, the movable assembly is able to avoid the limiting member.

When the timing assembly 500 of the embodiment is in use, in the first state, the knob portion 110 is rotated in the first direction (usually in the clockwise direction) to preset the timekeeping time of the timer 300, and the timer 300 starts to work. After the preset time is reached, the timer 300 can be automatically turned off. In addition, when the timer 300 has a non-human failure, for example, if the timer 300 does not stop working after the preset time is reached, then the limiting member of the timing assembly 500 can prevent the timer 300 from jumping to the second state, and prevent the machine from working all the time, so as to avoid safety risks. In addition, the preset time for the timer 300 set by the user may be too long and exceed the actual needed time, for example, the needed time is 30 minutes but the user has set the time as 45 minutes or even more, in this case, the user may need to perform a zeroing operation on the timer 300 initiatively, and need to rotate the knob portion 110 in the second direction (usually counterclockwise). Since the direction of rotating the timer 300 from the working state to the OFF position is consistent with the direction for choosing the second state, it is possible that the timer 300 is always working while the user thought that the timer 300 was turned off, which will incur safety risks. In this case, the limiting member provided can prevent the above two events from occurring, and the safety is greatly improved; when it is necessary, it is possible to choose the second state through the movable assembly 120 disposed on the knob assembly 100, at this time, when the movable assembly 120 in the second state is rotated, the movable assembly is able to avoid the limiting member, in this way, it is convenience for the user to choose the timer 300 in the second state. The embodiment has a simple structure and can prevent safety risks.

Further referring to FIG. 2, the movable assembly 120 includes a button 122 and an elastic component. The button 122 is coupled to the knob portion 110 through the elastic component. The elastic component used in the embodiment may be a spring 124. Of course, other components having the same function of generating elasticity are also acceptable. When the movable assembly 120 is in the first state, the button 122 is in a non-pressed state; when the movable assembly 120 is in the second state, the button 122 is in a pressed state, so as to compress the spring 124, and the knob portion 110 can avoid a baffle 201.

Wherein, the knob portion 110 includes a connection column 112 and a barrel portion 114. The connection column 112 is disposed at the bottom of the barrel portion 114, and the connection column 112 is fixedly coupled to the shaft 302. An opening is disposed on a sidewall of the barrel portion 114, a part of the button 122 is located inside the opening, thereby it is convenient for the user to press the button 122, and further to change the states of the movable assembly 120. And another part of the button enters into the barrel portion 114, and the spring 124 is located between the button 122 and the connection column 112, so that the button 122 is elastically coupled to the connection column 112.

Further referring to FIG. 3, it is an assembly diagram of the knob assembly of the timing assembly shown in FIG. 2. As shown in FIG. 3, the embodiment, in the first step, firstly assembles the spring 124 and the button 122, and proceeds to the next step after the assembling is finished, as shown with A in the figure; in the second step, further assembles the knob portion 110 with the two assembled in the first step, as shown with B in the figure. The structure is simple and the assembling is convenient.

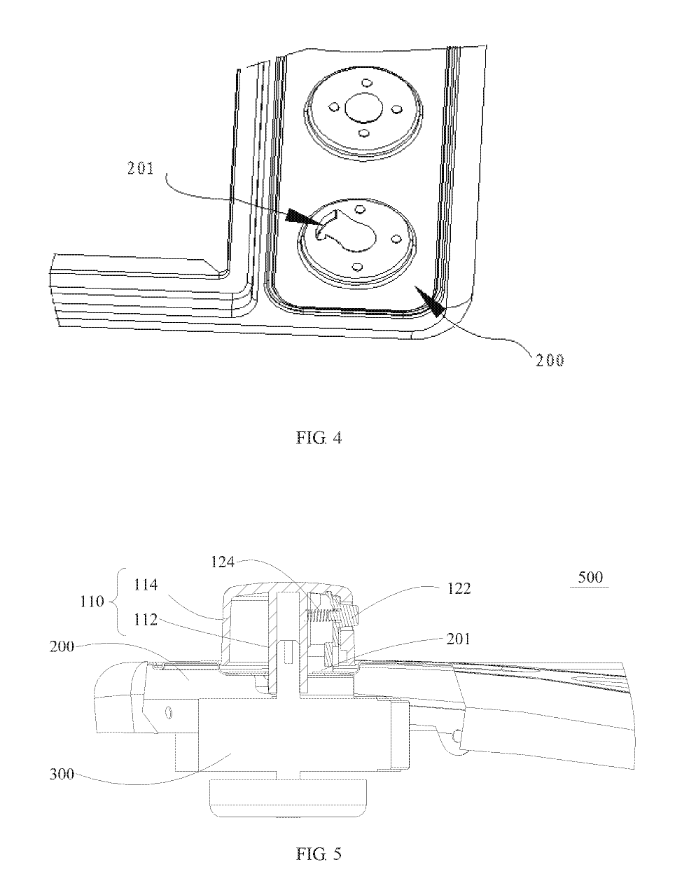

Further referring to FIG. 4, it is a partial schematic view of the mounting panel 200 of the timing assembly 500 shown in FIG. 1. As shown in the figure, a limiting member is disposed on the mounting panel 200. The preferred limiting member of the embodiment includes a baffle 201, and the baffle 201 is disposed on the mounting panel 200 and protrudes out of the mounting panel 200. Of course, the limiting member having other structures that serve the same function can also be used.

Further referring to FIG. 5, it is a sectional view of the timing assembly 500 in the first state in one embodiment. In FIG. 5, after the preset time for the timing assembly 500 is reached, the baffle 201 can prevent the button 122 from continuing rotating, further prevent the knob portion 110 on the knob assembly 100 from continuing rotating, so that the timer 300 can stop timing immediately, and correspondingly the apparatus can stop working.

In addition, the part of the button 122 that enters into the barrel portion 114 has a protrusion disposed at a side facing the connection column 112, and the spring 124 is sleeved on the protrusion. And the shape of the protrusion preferably mates with the shape of the spring 124, the protrusion is simple in structure and can make sure that the spring 124 can be better fitted with the button 122.

Of course, in order to prevent the spring 124 and/or the button 122 from detaching from the knob assembly 100, an anti-detachment structure can be disposed inside the knob 110 to prevent the spring 124 and/or the button 122 from detaching. In the embodiment, a retaining ring can be used, and other structures with the same function can also be used. And the retaining ring can be disposed inside the opening, and fits with the opening by a transition fit or an interference fit, and the retaining ring (not shown in the figures) mates with the part of the button 122. Since the retaining ring mates with the part of the button 122, an axial movement of the button 122 can be prevented, so that the relative distance of the button 122 relative to the knob portion 110 remains unchanged, and only the expansion amount of the spring 124 is changed when the button 122 is pressed.

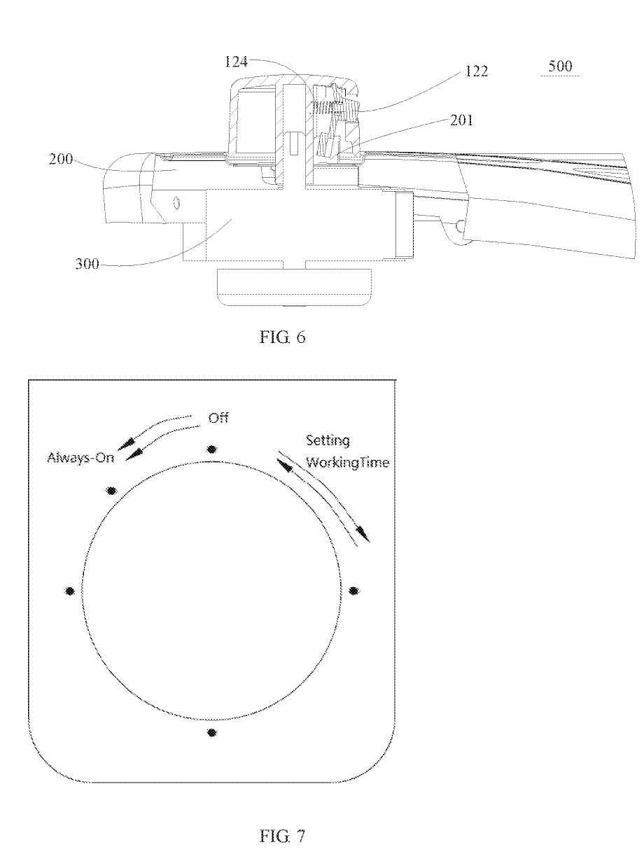

Further referring to FIG. 6, it is a sectional view of the timing assembly 500 in the second state in one embodiment. As shown in FIG. 6, when the timing assembly 500 needs to work in the second state, it is simply needed to press the button 122, so that the button 122 is in the pressed state to compress the spring 124, and thus the button 122 can avoid the baffle 201, and the knob portion 110 can rotate normally.

Further referring to FIG. 7, it is a diagram illustrating a working scene for the timing assembly 500 in accordance with one embodiment. As shown in FIG. 7, the timing assembly 500 has two states, and the first state is clockwise rotation to preset the timekeeping time of the timer 300. When the actual working time is less than the preset time, the user needs to manually reset the timer to zero position, and the rotation direction is counterclockwise. While the rotation direction for choosing the second state (that is, the stay-on mode) is consistent with the direction for zeroing, both are counterclockwise, which is easy to cause safety risks. While the limiting member and the movable assembly 120 arranged according to the present disclosure can be conveniently used for choosing the two states, and can avoid the above-mentioned safety risks as well.

The working principle of the disclosure will be further described below:

When the user uses the timing assembly 500 in the first state, and manually turns off the timer 300 in the working state, the baffle 201 can block the knob portion 110 and the button 122 from continuing rotating towards the second state as long as the timer 300 reaches an OFF position. Thereby the timer 300 is prevented from reaching the second state. When the user needs to use the timing assembly 500 in the second state, the user presses the button 122 with a finger to make the button in a pressed state, the spring 124 is compressed, and the button 122 avoids the baffle 201, as shown in FIG. 6. Thereby, the knob portion 110 can rotate normally from the first state to the second state, without affecting the user's using the timing assembly 500 in the second state.

In addition, the apparatus can prevent the timer 300 from jumping to the second state to cause the machine to be working all the time when a failure occurs, avoiding the potential safety risks caused thereby.

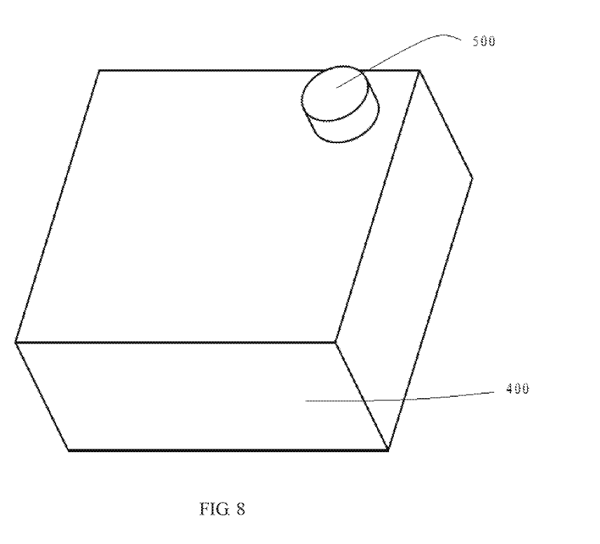

Further referring to FIG. 8, it is a schematic diagram of a toaster oven, relating to a second aspect of the present application. The toaster oven includes a toaster oven body 400 and the timing assembly 500 according to any of the above embodiments, wherein the timing assembly 500 is disposed on the toaster oven body 400. Referring to FIG. 2 together, when the toaster oven needs to be used in the first state, it is only needed to rotate the knob portion 110 on the timing assembly 500 in the clockwise direction, and when the knob portion 110 is rotated to a desired scale position, the knob 110 is released, then the electric contacts inside the timer 300 are connected, and the toaster oven starts to work. When the toaster oven needs to be used in the second state, the movable assembly 120 in the timing assembly 500 can be changed to the second state, and the limiting member can be avoided in this case. For a more specific structure of the timing assembly 500, references may be made to the timing assembly 500 described in the first aspect of the present disclosure, which are not repeated herein.

The technical features of the above-described embodiments can be arbitrarily combined. For simplicity, not all possible combinations of the technical features in the above embodiments are illustrated. However, the combinations shall fall into the scope of the present disclosure as long as there is no contradiction among the combinations of these technical features.

What described above are a plurality of embodiments of the present disclosure, they are relatively concrete and detailed, but not intended to limit the scope of the present disclosure. It will be understood by those skilled in the art that various modifications and improvements can be made without departing from the conception of the present disclosure, and all these modifications and improvements are within the scope of the present disclosure. The scope of the present disclosure shall be subject to the accompanied claims.

1. A timing assembly comprising:
a mounting panel;
a knob assembly, comprising a knob portion and a movable assembly, the knob portion being located at one side of the mounting panel, the knob potion being rotatable relative to the mounting panel, and the movable assembly being connected to the knob portion and capable of rotating with the knob potion, and the movable assembly having a first state and a second state;
a timer, comprising a body and a shaft, the body being located at another side of the mounting panel, and the body being fixedly connected to the mounting panel, and the shaft being disposed on the body, and the shaft and the knob portion being fixedly connected; and
a limiting member, fixedly connected to the mounting panel, the limiting member being positioned at a location corresponding to the movable assembly in the first state, when the movable assembly in the first state is rotated to the location of the limiting member, the limiting member being able to block the movable assembly from continuing rotating, and when the movable assembly in the second state is rotated, the movable assembly being able to avoid the limiting member.

2. The timing assembly according to claim 1, wherein the movable assembly comprises a button and an elastic component, and the button is connected to the knob portion by the elastic component.

3. The timing assembly according to claim 2, wherein the elastic component is a spring.

4. The timing assembly according to claim 3, wherein the button is in a non-pressed state when the movable assembly is in the first state, and the button is in a pressed state when the movable assembly is in the second state.

5. The timing assembly according to claim 2, wherein the knob portion comprises a connection column and a barrel portion, and the connection column is disposed at a bottom of the barrel portion, and the connection column is fixedly connected to the shaft;
an opening is disposed on a sidewall of the barrel portion, a part of the button is located in the opening, and another part of the button enters into the barrel portion, and the elastic component is located between the button and the connection column, so that the button is elastically coupled to the connection column.

6. The timing assembly according to claim 5, wherein the part of the button that enters into the barrel portion has a protrusion disposed at a side facing the connection column, and the elastic component is sleeved on the protrusion.

7. The timing assembly according to claim 5, wherein the knob assembly further comprises an anti-detachment structure, and the anti-detachment structure is able to prevent the elastic component and/or the button from detaching from the knob portion.

8. The timing assembly according to claim 7, wherein the anti-detachment structure comprises a retaining ring, and the retaining ring is disposed inside the opening, and fits with the opening by a transition fit or an interference fit, and the retaining ring mates with the button.

9. The timing assembly according to claim 8, wherein the limiting member comprises a baffle, and the baffle is disposed on the mounting panel, and protrudes out of the mounting panel.

10. A toaster oven comprising a toaster oven body and a timing assembly according to claim 1, wherein the timing assembly is disposed on the toaster oven body.

11. The toaster oven according to claim 10, wherein the movable assembly comprises a button and an elastic component, and the button is connected to the knob portion by the elastic component.

12. The toaster oven according to claim 11, wherein the elastic component is a spring.

13. The toaster oven according to claim 11, wherein the button is in a non-pressed state when the movable assembly is in the first state, and the button is in a pressed state when the movable assembly is in the second state.

14. The toaster oven according to claim 11, wherein the knob portion comprises a connection column and a barrel portion, and the connection column is disposed at a bottom of the barrel portion, and the connection column is fixedly connected to the shaft;
an opening is disposed on a sidewall of the barrel portion, a part of the button is located in the opening, and another part of the button enters into the barrel portion, and the elastic component is located between the button and the connection column, so that the button is elastically coupled to the connection column.

15. The toaster oven according to claim 14, wherein the part of the button that enters into the barrel portion has a protrusion disposed at a side facing the connection column, and the elastic component is sleeved on the protrusion.

16. The toaster oven according to claim 14, wherein the knob assembly further comprises an anti-detachment structure, and the anti-detachment structure is able to prevent the elastic component and/or the button from detaching from the knob portion.

17. The toaster oven according to claim 16, wherein the anti-detachment structure comprises a retaining ring, and the retaining ring is disposed inside the opening, and fits with the opening by a transition fit or an interference fit, and the retaining ring mates with the button.

18. The toaster oven according to claim 17, wherein the limiting member comprises a baffle, and the baffle is disposed on the mounting panel, and protrudes out of the mounting panel.
